(19) United States
(12) Patent Application Publication
(10) Pub. No.: US 2023/0360151 A1
(43) Pub. Date: Nov. 9, 2023

(54) SELF-CUSTOMIZING, MULTI-TENANTED MOBILE SYSTEM AND METHOD FOR DIGITALLY GATHERING AND DISSEMINATING REAL-TIME VISUAL INTELLIGENCE ON UTILITY ASSET DAMAGE ENABLING AUTOMATED PRIORITY ANALYSIS AND ENHANCED UTILITY OUTAGE RESPONSE

(71) Applicant: Deepak SWAMY, San Jose, CA (US)

(72) Inventor: Deepak SWAMY, San Jose, CA (US)

(21) Appl. No.: 18/138,480

(22) Filed: Apr. 24, 2023

Related U.S. Application Data
(63) Continuation-in-part of application No. 15/659,201, filed on Jul. 25, 2017, now abandoned.
(60) Provisional application No. 62/366,135, filed on Jul. 25, 2016.

(51) Int. Cl. G06Q 50/06; G06Q 10/0631; G06Q 10/20

(52) U.S. Cl. CPC G06Q 50/06; G06Q 10/06316; G06Q 10/20; G06Q 10/063114

(57) ABSTRACT

A self-customizing, multi-tenanted mobile system includes digitally gathering and disseminating real-time visual intelligence on utility asset damage enabling automated priority analysis and enhanced utility outage response. A preferred embodiment may be made up of, for example, communication module (102) to transfer geo-coded damage imaging and associated metadata simultaneously from multiple outage-causing damage locations to dispatchers and operations personnel in the utility control room and in the field. A mobile application (101) is installed onto the first responder's Global Positioning System (GPS) enabled mobile device (104) to send metadata to a multi-tenanted intelligent platform (MTIP) (106). MTIP (106) determines which utility tenant receives the damage report and customizes all aspects of the technical solution: the first responder mobile application (101), the central web portal (103) and the damage viewing application for utility field personnel (110). A central web portal (103) running on a control room personal computer running a Javascript capable browser or similar environment (105) receives geo-coded damage imaging and associated metadata from mobile application (101) via the MTIP (106) which automatically analyzes event location, relevance and severity to compute, recommend and communicate event priority. MTIP (106) further analyzes inbound images using computer vision technology and wire geometry algorithms to determine relative risk and event priority of downed wires. The multi-tenanted intelligent platform (106) is used to store outage-causing damage information and perform damage assessment enabling dispatchers to respond appropriately. A preferred embodiment enables external users—specifically municipal first responders (fire, police and municipal workers) to report outage-causing damage to the electric grid and provides a simple, easily deployable and secure system. The system then uses location, severity and role-based rules to dynamically notify appropriate utility personnel (112) via text message, email notification or within the damage viewing application on the field personnel's mobile device (110) so they are best able to respond and repair the damage. A preferred embodiment also speeds and improves communication between municipalities and utilities, and enhances the transparency of utility damage repair leading to outage resolution.

### RELATED APPLICATION

This application is a continuation-in-part of U.S. patent application Ser. No. 15/659,201, filed Jul. 25, 2017, which claims the benefit of U.S. Provisional Application No. 62/366,135, filed Jul. 25, 2016, the entire contents of which are incorporated herein by reference.

### BACKGROUND OF THE INVENTION

### Field of the Invention

The present application relates to a system and method for digitally gathering and disseminating real-time visual intelligence on utility asset damage enabling automated priority analysis and enhanced utility outage response.

### Background of the Related Art

During a power outage, gathering of information regarding damage to service-enabling grid assets is crucial. Delays in collecting accurate information regarding the nature and extent of damage can result in compounded delays in the repair and restoration process. These industries use a plurality of networks or systems to identify/sense, confirm and track the severity of grid damage that causes an outage, following which the utility's operations planners, dispatchers and control room operations personnel create repair work orders and dispatch the appropriate repair crews to restore the interrupted service.

The main objective of the outage management system is to locate customer outages and respond rapidly by sending the required resources to make repairs and expeditiously restore service. However, current outage management systems are hindered by the lack of timely situational awareness. This is because these systems are primarily designed to identify customers and customer facilities (e.g. electric meters) that are experiencing or have experienced a service outage. Further, these systems use sensor and communication technology from smart devices in the electric distribution network to generate a “probable cause” for customer outages. The majority of customer outages in North America, however, occur because of damage to poles and pole-based utility assets caused by extreme weather, trees or animals. Such damage cannot easily be remotely detected, nor can it be precisely pinpointed. To obtain actual root cause including type, location and extent of the damage that caused an outage, utilities must dispatch technicians to the field to conduct a detailed “damage assessment,” cataloging the damaged poles, wires and other passive elements of the electric distribution network. The available systems consolidate data from “smart” devices but do not automatically detect overhead distribution network damage that is frequently at the root cause of an outage. Qualified electrical damage assessors must manually record and catalog damage to the poles and pole-based assets that lie at the root cause of the outage. During a large outage event, the grid can be damaged at thousands of locations in a single State or geographic area, necessitating a large—and unavailable number of qualified electrical damage assessors.

One current solution is to press additional utility employees into service. These employees are often not qualified electrical personnel but have been trained to manually record damage inflicted to utility assets. Most commonly, municipal firefighters and police officers, often first on the scene of downed poles or trees often “call in” damage and report it to be the highest available priority. Those first responders initially report the damage to the 911 (fire or police) dispatcher via two-way radio. The 911 dispatcher must then call the utility via landline telephone to report the damage to the utility call center. The damage report is usually manually entered and forwarded by the utility call center to a utility dispatcher, who then in turn dispatches a utility technician to the scene to evaluate the damage and assess the resources needed for repair. However, those first responders (fire and police) may not have the technical knowledge to accurately assess the damage and may report an incorrect priority level, or report damage that is unrelated to the electric distribution network (telephone or cable television, for example). There may be transcription errors due to multiple verbal “hops” in the inter-organizational communication process. Finally, damage location data may be incorrect. Until the utility can dispatch its own personnel to assess damage, the utility has no means of accurately assessing the true severity and priority of such first responder “call-ins.” During extreme weather events, first responders may arrive at a damage location when roads may be blocked or driving conditions may be unsafe, during which time the utility is usually unaware of the type or extent of damage to their assets, and therefore unready to mobilize resources needed for repairs. The result is wasted, precious resources and time, delaying true situational awareness of the grid damage that caused the outage and ultimately the timely restoration of power to affected customers.

### BRIEF DESCRIPTION OF THE DRAWINGS

The foregoing and other features of embodiments will become more apparent from the following detailed description of exemplary embodiments when read in conjunction with the accompanying drawings. In the drawings, like reference numerals refer to like elements.

FIG. 1 illustrates a block diagram of the system for digitally gathering and disseminating real-time visual intelligence on utility asset damage enabling automated priority analysis and enhanced utility outage response incorporating location-pinned imaging during a power outage, in accordance with an embodiment of the preferred embodiment.

FIG. 2 illustrates a block diagram of the process for the utility asset damage intelligence gathering and dissemination, in accordance with an embodiment of the preferred embodiment.

FIGS. 3(a), (b) illustrate a process flow for utility asset damage intelligence gathering and dissemination during a power outage.

FIG. 4 illustrates a preferred embodiment self-configured to serve multiple “tenants” or asset owners and operators (utilities), each with their own geographic service territory, service types and processes for handling “911 calls” from first responders reporting damage to the grid.

FIG. 5 illustrates a preferred embodiment implemented (e.g., using computer vision algorithms) to analyze images in determining relative risk and event priority.

FIGS. 6-7 are block diagrams showing system subsystems.

### DETAILED DESCRIPTION OF PREFERRED EMBODIMENTS

As will be apparent from the description herein, utilizing the preferred method and/or apparatus implementing the invention, the problems in the prior art are overcome. For example, a preferred system, in accordance with preferred embodiments, automatically gathers and disseminates visual intelligence on utility asset damage and prioritizes utility damage response based on location, relevance and severity. During an extremely busy outage event, better, more situation-appropriate prioritization of damage will provide a foundation of better information that will yield better, more timely deployment of the required type and number of resources in line with the true priority of an event. By directly notifying field-based crews and supervisors of grid damage within their jurisdiction and of a type serviceable by their crew utilities can ensure the near-instant digital dissemination of visual intelligence of the damage that caused an outage. This will lead to more accurate dispatch and better overall repair and power restoration outcomes-all achieved utilizing embodiments of the invention.

Moreover, in accordance with embodiments of the invention, better prioritization does not come at the expense of simplicity of user experience. With as few as six touches on a smartphone application in accordance with preferred embodiments, first responders will be able to gather visual intelligence of utility asset damage (consisting of geo-coded imaging with associated damage metadata) at the precise location of grid damage that is at the root cause of the outage. Utilizing these embodiments, accurate and well-prioritized visual intelligence on utility asset damage can be digitally gathered and disseminated in real time to various utility personnel located at the utility control room and in the field so as to enable them to respond quickly and effectively to repair outage-causing grid damage. The preferred embodiments also provide a simultaneous, distributed and syndicated processing in which utilities interact with municipalities, towns, and/or communities to collect visual intelligence on damage to utility assets.

In accordance with preferred embodiments, a system and method is provided to automatically and intelligently interpret incoming metadata and images on the basis of several key parameters. First, precise geo-location is dynamically and “pattern-matched” (e.g., in real-time, near real-time, etc.) against active service areas, supervisory span of control, recent and prior damage reports from first responders, and other parameters to yield a factor used to compute priority. Priority is also computed on the basis of relevance, comprised of user-, role- and geo-spatial relevance, helping to match incoming data with supervisors and field personnel best able to address the issue at hand. Finally, the system (and method) is able to process captured images to determine severity, on the basis of expected and actual wire geometries and placement. This relies on the relative placement geometry of distribution and service wires of varying voltages on electric poles. Priority can therefore be computed on the basis of location, relevance and severity.

Preferred embodiments, thus, overcome the drawbacks in the prior art and provide a system for (and method of) automatically gathering, disseminating, prioritizing and managing visual intelligence on grid damage employing location-pinned imaging during a power outage. A preferred embodiment separates the process of damage reporting and damage assessment, enabling first responders (fire and police personnel) arriving first at the scene of utility damage (damage site) to quickly capture essential information regarding the root cause of the outage to utility technicians, wherein the utility technicians may then remotely perform the damage assessment. Reporting can be done by persons with little or no electrical knowledge other than basic electrical safety training, such as firefighters and police officers (first responders). Assessment is done by qualified electrical technicians, such as the utility technicians, to interpret the reports that are transmitted using the preferred embodiment.

One preferred embodiment comprises a two-way wireless communication module to transfer geo-coded damage imaging and associated metadata from the outage location to the multi-tenanted intelligent platform and then to the utility dispatch center or Emergency Operations Center (EOC). A mobile application is installed onto a Global Positioning System (GPS) enabled first mobile device and can be utilized for instance, by a first responder. Using this application, the device stores and sends geo-coded damage imaging and associated metadata from the outage location to a multi-tenanted intelligent platform for storage, analysis and disposition.

The multi-tenanted intelligent platform (MTIP) is capable of receiving first responder damage reports from any location in North America (and may be extended to the world), evaluating the damage report and determining which utility tenant is affected and which tenant's central web portal must receive the damage report. It does this by creating a “geo-fence” that encircles each tenant utility's service territory or operating boundary, and determining which tenant utility the first responder damage report must be submitted to. The MTIP has the effect of allowing each utility tenant to operate a customized version of the first responder application, central web portal and damage viewing application, with the customization being delivered as the MTIP senses the reporting first responder's GPS location and damage type. Thus, the information provided by the first responder mobile device can contain information that is customized to the specific utility. In addition, the MTIP determines the utility that is to receive the first responder's damage report. For instance, the damage type can be utilized to determine if a gas or electric utility is to receive the damage report. And the geographic information can be utilized to confirm the specific utility that services that area.

The MTIP also performs various other important functions such as the encryption and archival of information submitted from the first responder application, location-based clustering of events and location-based cybersecurity measures to prevent distributed denial of service (DDOS) and other forms of cyber-attacks. While the closed and trusted user group of first responders (fire and police officials) with the responsibility for ensuring public safety offers low risk, the MTIP ensures that only authorized users may submit, view or manage damage reports that are submitted using the first responder damage reporting application.

A central web portal running on a control room personal computer (PC) receives (e.g., in real-time, near-real-time, or as otherwise implemented) the geo-coded damage imaging and associated metadata from the mobile application through the multi-tenanted intelligent platform which can automatically prioritize response based on location, relevance and severity. The central web portal can be accessed by the utility dispatcher at a control room personal computer within a Javascript-capable web browser or similar environment. A separate, delimited “town portal” may be accessed by town or county based emergency management departments (EMDs) or other town officials, with the town portal displaying first responder reported grid damage reports for their town or county with the possibility of viewing the utility's disposition of the report, such as “assigned to a crew,” or “crew on route.”

In accordance with a preferred embodiment, the multi-tenanted intelligent platform “pattern-matches” event location against active service areas, recent and prior damage reports from first responders, and other parameters to yield a factor used to compute priority. The system, for example, is able to automatically assign a higher priority when it senses a sequence of geo-clustered events within a particular category. The multi-tenanted intelligent platform measures event density of these geo-clusters or “hotspots” and therefore computes yet another priority assignment factor for the entire sequence of events. Relevance may also drive event priority, and can be computed, for example, on the basis of user-, role- and geo-spatial relevance. Grid damage caused by trees impacting primary or secondary wires, for example, can automatically be routed to “vegetation management” crews with the specialized equipment needed to clear-cut a tree that has fallen across and taken wires down. Their work may need to be co-ordinated with other electrical crews or crews responsible for setting poles at locations where poles have been damaged beyond repair. Context and relevance analysis within the multi-tenanted intelligent platform takes into account the type of damage, its severity, the types of resource needed for repair, their proximity to the damage site before notifying the closest and most appropriate workers of the damage near them. This is preferably done by analyzing the incoming events based on the requirement for prerequisite specialized work that must be performed before generalized crews or workers can repair damage on arrival.

In the event of a downed pole, for example, a new pole must be installed prior to repairs to wires on the existing pole. When tree limbs fall on wires, causing an outage, a vegetation management or tree-trimming crew must first cut the tree limbs before the electrical work can be completed. The system automatically detects the need for prerequisite work and uses it to compute an additional event priority factor. Events that can be addressed by any crew encountering the event receive an alert message. Finally, the system performs image analysis or image processing to automatically determine severity of certain classes of events. Much utility asset damage is accompanied by significant changes to wire geometries and wire position. During “blue-sky” or normal operation, wires are placed in standard relative positions on utility poles, primary wires on top, with medium and low voltage at successively lower heights on the pole. Telephone and cable television lines are placed at the lowest positions. The multi-tenanted intelligent platform detects changes to normal or expected wire placement by processing captured images and can therefore automatically assign appropriate severity to the event. Severity when combined with location intelligence and relevance can algorithmically yield a more accurate recommended event priority which may then be recorded, displayed and communicated to users in the field.

A central web portal with a geospatial map view and real time event management is used for grouping, sorting, cataloging and organizing the damage assessment reports from first responders for the display in the utility control room on the control room personal computer. A selective notification module uses day-of-week, time-of-day, location- and role-based rules to send rich notifications via email, text message and app push to relevant utility users including utility dispatchers and local crew supervisors. Clicking on the links within these notifications allow workers and supervisors in the field to have instant visibility into the prioritized root cause of the specific set of causative events for the outage they aim to address. A separate report viewing mobile application is used by utility crews and crew supervisors in the field to view and respond to damage reports submitted by first responders.

A multi-tenanted intelligent platform is used to store the visual intelligence of grid damage and to automatically manage such information by tenant. The MTIP allows experienced technicians for the tenant utility to perform damage assessment, by viewing the damage reports on the central web portal. With detailed damage assessments done, utility dispatchers and crews in the field can respond appropriately to the outage-causing damage. The damage assessment reports from the first responders is further displayed on the town web portal which may be accessed by town and county emergency management departments and other town officials to provide assistance in the restoration process. Municipal authorities may further flag roads as being blocked and whether firefighters and police officers are standing by the damaged asset so that crews can determine whether and when to drive to the damage location to effect repairs.

In the preferred embodiment, the first responder is a user such as a firefighter, police officer, or municipal worker who is first on the scene of the damage.

In the preferred embodiment, the system further disseminates outage information with plurality of organizations on the utility tenant's central web portal and within the utility tenant's damage viewing application provided to field based crews via the multi-tenanted intelligent platform, wherein the shared information is used to form a strategy by the organizations to respond to the outage-causing damage.

In the preferred embodiment, the metadata may be any data pertaining to outage but not limited to the damage timeline, GPS-encoded pictures, damage classification (such as tree-took-wires-down, or transformer damage), videos, text, digital imagery, incident status, etc.

In another preferred embodiment, the system and method include the sending the geo-coded damage imaging and event meta-data to the multi-tenanted intelligent platform by the first responder using a mobile application at the utility damage location. The utility damage event is created, time-stamped and stored on the multi-tenanted intelligent platform. Notifications (e.g., in real-time, near real-time, etc.) are then sent via email, text message and app push to relevant utility users including utility dispatchers and local crew supervisors. The utility's local crews and crew supervisors may then view the detailed damage reports and associated images and metadata using a dedicated damage viewing mobile application, allowing them to quickly respond with the appropriate resources needed for repair. Damage assessment and prioritization can be accomplished remotely, reducing the need to roll a truck simply to ascertain the nature of the damage, and allowing the utility to send the required repair crew directly to the location of damage. The recommended priority of the resultant event is assigned automatically based on a number of factors such as the location, relevance and reported severity of damage. Damage assessment reports from first responders are catalogued, grouped, sorted and organized for display on the central web portal. Images and metadata may be exported to the utility's own geographical information system which they may use to track outage and storm locations overlaid on maps of their electrical circuits. Such export may take the form of map pins derived from damage geo-location. Qualified electrical technicians or utility damage assessors and dispatchers can use a control room personal computer to view the damage reports from the first responders on the central web portal to determine the required response. Such technicians may also view the damage in the dedicated damage viewing app on their smartphone while in the field. Accurate dispatch orders/work orders are prepared for utility crews. Crews are routed to exact damage address to complete the repair. Upon completion, the dispatcher and/or crew updates the damage ticket status to cleared or repaired. The municipalities and towns are allowed to view the updated ticket status of town or county based utility damage events on the town web portal.

In a preferred embodiment, the town web portal further provides the status updates to the first responder or the municipality of the first responder.

A preferred embodiment provides a multi-tenanted intelligent platform, which empowers the first responders with intuitive tools to quickly report damage and send the GPS-encoded pictures to pinpoint damage, thereby providing “eyes on” the scene, enabling remote damage assessment and prioritized damage response. A preferred embodiment reduces unnecessary truck rolls, enables utilities to restore power faster and improves collaboration and information sharing between a utility and their communities including but not limited to municipal officials and public safety officers.

Reference will now be made in detail to the description of preferred embodiments in connection with the set of drawing figures appended hereto. Each exemplary embodiment is provided to explain the subject matter and not a limitation. These embodiments are described in sufficient detail to enable a person skilled in the art to practice preferred embodiments of the invention, and it is to be understood that other embodiments may be utilized and that logical, physical, and other changes may be made within the scope of the embodiments. The following detailed description is, therefore, not be taken as limiting the scope of the invention, but instead the invention is to be defined by the appended claims.

The term “crowd sourcing” as used herein refers to the process of obtaining needed services, ideas, or content by soliciting contributions from a large group of people, and especially from an online community.

A preferred embodiment provides a system for digitally gathering and disseminating real-time visual intelligence on utility asset damage enabling automated priority analysis and enhanced utility outage response incorporating location-pinned imaging during a power outage. A preferred embodiment comprises a communication module that runs on the first responder mobile device, to transfer geo-coded damage imaging and associated metadata from the outage location to the multi-tenanted intelligent platform which then makes it available to the appropriate utility's dispatchers via a central web portal and to field based utility crews and crew supervisors via a dedicated damage viewing application on their GPS enabled mobile device. A mobile application is installed onto the first responder Global Positioning System (GPS) enabled mobile device to send geo-coded damage imaging and associated metadata from the outage location to a computing device, wherein the metadata is sent by the first responder through the mobile application. A central web portal running on the cloud-based computing device receives geo-coded damage imaging and associated metadata from the mobile application and prioritizes the response based on location, relevance and severity. A dedicated damage viewing application runs on the GPS enabled mobile device operated by the utility crew or crew supervisor, using which the crew can receive personalized notifications of grid damage that matches their crew type, jurisdiction and shift schedule. A multi-tenanted intelligent platform stores and processes the outage information and enables qualified electrical personnel to remotely perform the damage assessment using a central web portal. Armed with this information, utility dispatchers and field crews are simultaneously able to respond appropriately to the outage. The damage assessment report is further displayed on the town web portal which may be accessed by municipal authorities to coordinate vehicular access or to provide assistance in the restoration process.

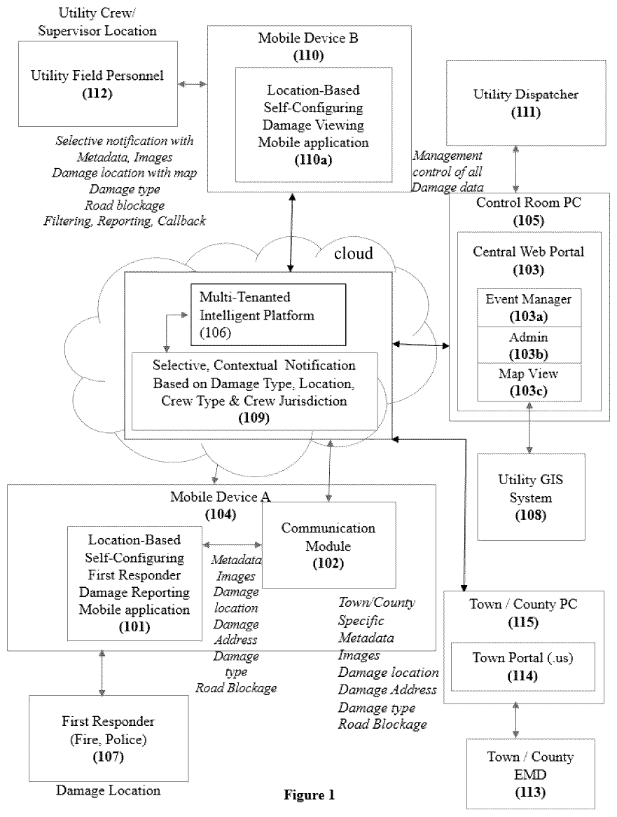

FIG. 1 illustrates a block diagram of the system (100) for digitally gathering and disseminating real-time visual intelligence on utility asset damage enabling automated priority analysis and enhanced utility outage response, in accordance with an embodiment of the preferred embodiment. A preferred embodiment comprises a two-way wireless communication module (102) to transfer the geo-coded damage imaging and associated metadata from the outage location to the utility central web portal running in a browser on the Control Room PC (105) through the multi-tenanted intelligent platform (106). A location-based, self-configuring first responder damage reporting mobile application (101) is installed onto a Global Positioning System (GPS) enabled first responder two-way mobile communication device (104) to send the geo-coded damage imaging and associated metadata from the outage location to a control room PC (105), for example, through the communication module (102) and the multi-tenanted intelligent platform (106), wherein the metadata is sent by the first responder (107) through the mobile application (101). The communication module (102) is based on an Automated Programming Interface (API) that enables the first responder damage reporting mobile application (101) to perform various communication functions including staged upload of images and metadata to the Multi-Tenanted Intelligent platform and enables the MTIP and the first responder damage reporting mobile application to synchronize with each other, updating information in either direction.

The updated damage information is displayed to the appropriate utility tenant on a central web portal (103), preferably accessible by or running on one or more control room personal computers within a Javascript capable browser or similar environment (105). This central web portal (103) may provide various subsystems including a real-time event manager (103a) enabling a utility dispatcher (111) to assign various dispositions (“acknowledged,” for example, or “assigned to a crew,” or “crew en route,” or other dispositions. The central web portal (103) may also include an admin portal subsystem (103b) enabling utility tenants to manage users, roles, privileges, jurisdictions and notifications. A third subsystem may include a map viewer or manager (103b) which may optionally integrate with the utility's geographical information system (GIS) (108). Town and county emergency management departments (EMDs) (113) can receive the metadata from the mobile application (101) within a town portal (114) on a town or county owned personal computer (115) within a Javascript capable browser or similar environment via the MTIP (106) which is programmed (e.g., running a series of computational algorithms, etc.) to automatically prioritize the event and event response based on a number of factors including but not limited to location, relevance and severity.

The invention can be integrated for use with external systems such as for instance a geographic information system (GIS) (108) that may be used to combine the map-based damage assessment reports from the first responders (103c), with other information such as storm/weather information, crew position etc. to make decisions regarding positioning or movement of resources or for other planning purposes. A selective notification module (109) is in communication with and draws on the MTIP (106) to determine which users must be notified based on the location of damage, the location jurisdiction, shift times and roles of utility personnel. This module is used to send the notifications via email, text message and app push to relevant field-based utility users including various types of crews and jurisdictional crew supervisors. The MTIP (106) securely stores the damage information and enables the utility dispatcher to use the central web portal (103) to perform damage assessment so the utility may respond appropriately. Qualified electrical personnel at the Utility Control room personal computer (105) or in the field (112) using mobile device (110) running the location-based self-configuring damage viewing mobile application (110a) can, securely view, filter and update visual damage assessment reports from the first responders, that enable utilities to pinpoint damage and dispatch the right personnel (112) to restore services that are interrupted. The damage assessment report is further displayed on the town web portal (114) running on the town or county personal computer (115) within a Javascript capable web browser or similar environment which may be accessed by the town or county emergency management department (EMD) (113) for towns to co-ordinate efforts and to gain better visibility into the restoration process.

In one aspect of a preferred embodiment, in the form of a system, the first responder (107) may be one or more individuals such as a firefighter, police officer, a municipal worker or any external individual with basic electrical safety training arriving first at the damage location. The first responder quickly generates damage reports and notifies utility personnel (111, 112) via mobile application (101) installed onto the mobile device (104), and take GPS-encoded pictures.

In another aspect of the exemplary system, the system helps electric utility companies to restore power more effectively by “crowd sourcing” the visual intelligence on the state of assets in the electric grid from community-based fire and police personnel using a mobile application. This enables utilities to improve outage response by pinpointing damage to utility assets, wherein outage response is optimized by prioritizing based on location, relevance and severity. The restoration process is initiated by performing repairs with the appropriate manpower and resources.

In another preferred embodiment, the system helps the utility categorize and prioritize asset damage events at the point of occurrence by enabling first responders (e.g., fire and police personnel) to provide essential imaging and associated metadata illustrating, for example, a downed tree limb on a live power line, a downed power line etc. The provided metadata helps the utility dispatcher to respond appropriately. The system also performs early determination of outage cause with the help of first responders arriving first at the scene, even before utility personnel can be dispatched in the event of blocked roads or hazardous conditions such as an ongoing fire that is not yet fully under control.

Another preferred embodiment further shares outage information with a plurality of organizations on the central web portal, wherein the shared information is used to form an appropriate strategy to respond and repair the damage that caused the outage. Various stakeholders provide feedback throughout the outage management process, wherein the key performance indicators, outage restoration data, and round-trip restoration intervals may be tracked, wherein these data are used to enhance outage preparation and management.

In another preferred embodiment, the system improves and speeds effective communication with imaging between municipalities and utilities and enhances the transparency of the utility's outage response process. This has the effect of further improving the quality and quantity of “early warning” information available to utilities from first responders in municipalities, acting as extended “eyes in the field”.

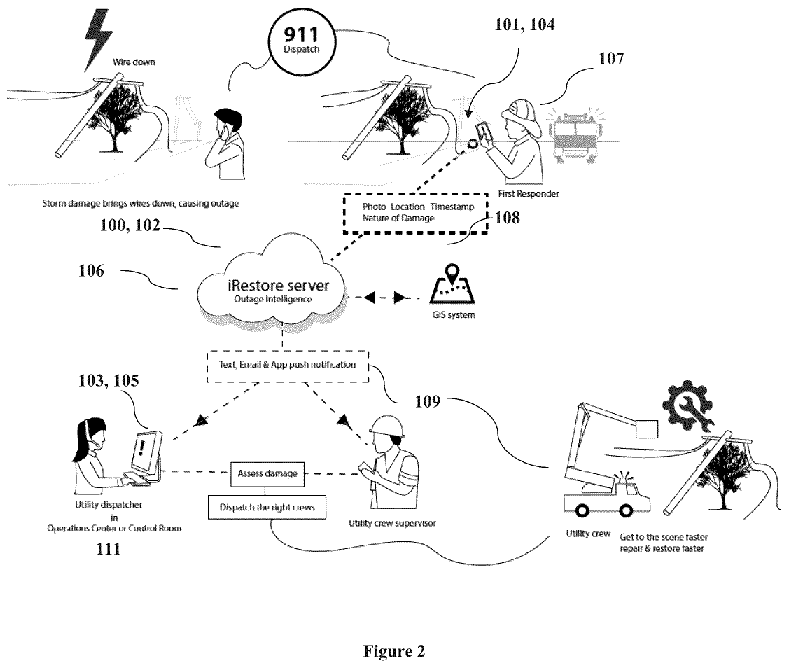

FIG. 2 illustrates a block diagram of the process for digitally gathering and disseminating real-time visual intelligence on utility asset damage enabling automated priority analysis and enhanced utility outage response, in accordance with a preferred embodiment. The preferred embodiment provides two-way communication about utility asset damage, which enables the first responders (107) to use the mobile application (101) on the mobile device (104) to create the damages report and to send the damage report directly to the utility, and enable utility dispatch centers to provide status updates of the damage assessment report back to the municipalities. The secure town web portal (103) may be used by city, town and municipal personnel, and officials to view the status of utility reports created in response to first responder reports of utility damage.

A preferred embodiment provides “eyes on” damage visibility, location, and situational awareness to dispatchers, crew supervisors, and the utility emergency operations center. In one aspect of a preferred embodiment, the system uses mobile devices such as smart phones, tablets etc., to allow fire, police personnel, municipal field workers or utility crewmembers to be part of the solution and provide visual intelligence of damage to utility assets to aid in the repair and outage restoration process.

The damage assessment is performed using geo-coded imaging, damage metadata, wherein the damage assessment process is a simultaneous, distributed and syndicated process, wherein the utilities tie-up with towns and communities to collect visual intelligence on damage to utility assets.

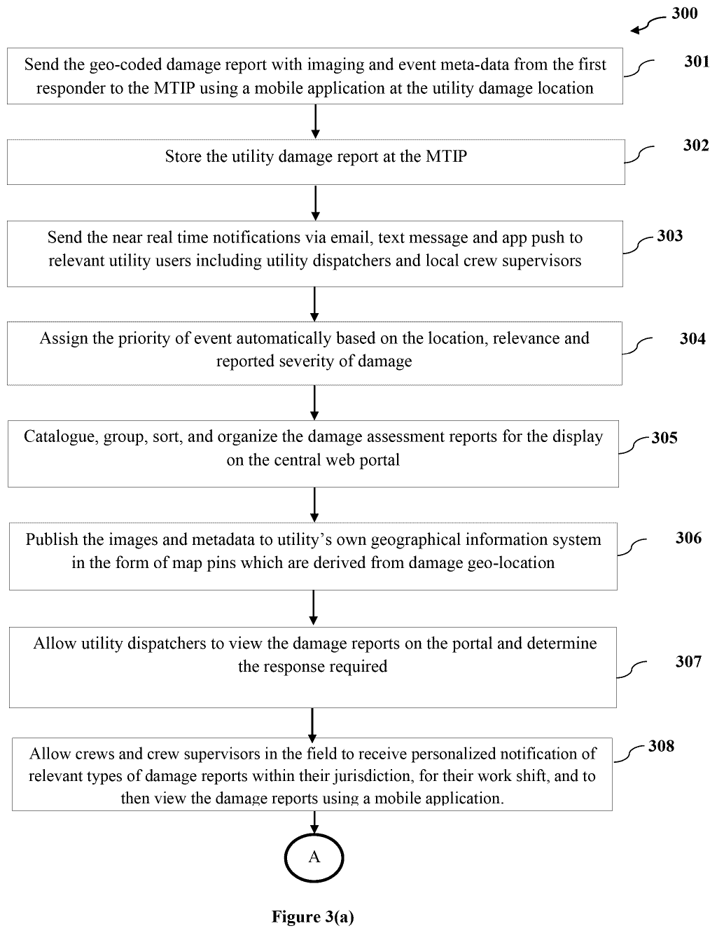

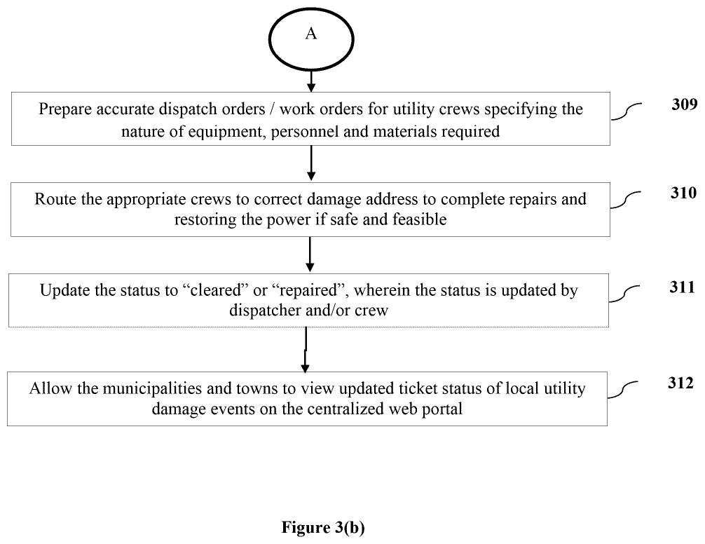

FIGS. 3(a), (b) illustrate a process flow for digitally gathering and disseminating real-time visual intelligence on utility asset damage enabling automated priority analysis and enhanced utility outage response. The system operation (300) initiates with the step at (301), in which geo-coded damage imaging and event metadata is sent to the multi-tenanted intelligent platform, for example, by the first responder who may use a smartphone application at the utility damage location. Here, the first responder (107) uses the first responder mobile device (104) to create a damage report. In one non-limiting embodiment to illustrate the invention, the mobile application (101) presents the user with a number of menu options having damage types or categories, such as tree, wire, pole, electric equipment, gas equipment, or fire. The first responder (107) can select the appropriate damage category, and can be presented with a number of sub-category options. For example, if a tree has fallen on wires, the user selects tree and can be presented with sub-categories of tree on wire burning, tree took wire down, and tree on wire. If the user selects the damage category for wire, the sub-categories are displayed for wire arcing, wire down/damage, and low hanging wire. If the user selects the damage category for pole, then the sub-categories can be pole motor vehicle accident (MVA), pole down/damage, and pole leaning. If the user selects the damage category for electric equipment, the sub-categories can be meter damage, transformer damage, and other damage. Such categories and sub-categories can vary by utility tenant and the MTIP (106) can automatically signal the mobile application (101) to display the customized choices for the utility tenant based on first responder location and damage type. Thus, the first responder application is “self-customizing,” since the it detects the utility tenant by communicating to the MTIP (106) and automatically loads the categories and subcategories defined by and associated with that utility tenant.

Once the damage category and sub-category, if there is one, are selected, the mobile application (101) automatically opens the camera interface. Once the user (107) takes a picture, the application (101) automatically notes the geographic location (latitude and longitude) from the GPS-enabled mobile device (104). The location and a date and time stamp are associated with the captured image(s). The application (101) then creates a damage report preview with all the event metadata (or incident information), including the damage category, damage sub-category, image data, and geographic information. The geographic information can include the geographic information displayed on a map with a pin indicating the location, as well as the street address based on the location. The event metadata also indicates first responder identification information (user profile) such as the mobile number, name, organization (fire or police department by town, for example) email address, and the like. The application also logs the location, type and version of operating system of the device for registration and security purposes.

Users must either be pre-authorized by the utility tenant or must request authorization from the utility admin in the admin portal (103b). The user (107) can also indicate other event data, such as an option for if the road is blocked and if police and/or fire are standing by. Other event data can be added as well, such as equipment ID (pole/device number), and first responder comments. It is noted that the damage report only requires general information from the first responder about the event, and the first responder does not need to indicate any detailed technical information about the damage. The technical information can be confirmed later by the utility dispatcher (111) or the utility field personnel (112) by viewing the damage report and the associated images. Thus, the first responder should not have any difficulty in providing the information. The mobile application (101) also makes available to the first responder, all prior damage reports submitted by that first responder for viewing, together with a status indicator showing the current status of that report, such as awaiting upload, submitted, utility crew on its way, or fixed.

Thus at step (301), the utility damage report with event metadata is created, time-stamped and sent from the mobile device (104) to the multi-tenanted intelligent platform (106). At step (302), the damage report is received and stored at the multi-tenanted intelligent platform (106), and is made available at the web portal (103). At step (303), notification can be sent, for example, via email, text message, app push, or other means to the relevant utility users including utility dispatchers (111) and local crew supervisors (112). This can be done automatically, for example, by the notification module (109) that is in communication with the multi-tenanted intelligent platform (106).

Damage reports may also be forwarded for viewing by field based utility crews or crew supervisors (112) using a dedicated location-based self-configuring damage viewing mobile application (110a) running on the field based utility crew's mobile device (110). For example, the notifications module (109) can send a confirmation receipt to the first responder (107) via the first responder mobile device (104), and can send the damages report to the field based utility personnel (112) via a utility personnel mobile device (110) that have been identified as the appropriate crew assigned to go to the damage location to perform repairs.

The notifications module (109) forwards all or part of the damages report to the various users, as appropriate, either in the form of a text message or an email. For example, the notifications module (109) will automatically forward only those damage reports relevant to a particular town or county to the town and county processing device (115). And it will only forward those damage reports requiring a tree-trimmer (or high-voltage crew or a pole-setting crew) to the utility crews that are identified as having the capability of conducting tree-trimming (or high-voltage expertise or pole-setting expertise), which the notifications module (109) can determine based on the information in the damages report, such as for example by automatic analysis of the picture and/or the category and sub-category data. The MTIP can control the web portal (103) to define which utility tenant can access the first responder damage report and other information and reports. The utility processing device (105) receives a complete set of data, and can control the MTIP (106) to define what information is sent to each of the processing devices (110), (104), (115), and what information is accessible to that utility via the web portal (103).

At step (304), the priority of event is computed by the web portal (103), updated and distributed to users automatically by the notifications module (109) based on the location, relevance and determined severity of damage. As noted previously, the priority can be based on a number of factors that are automatically determined and can optionally be manually confirmed or supplemented. Those factors are based on the event metadata provided in the first responder damage report, such as an evaluation of the captured images, location, and/or other damages reports.

At step (305), the damage assessment reports are catalogued, grouped, sorted and organized for display, for example, on the central web portal (103). At step (306), the images and metadata are published, for example, in the utility's own geographical information system (108) in the form of map pins derived from damage geo-location. The reports can be displayed on the central web portal (103) in any suitable manner, such as by damage category, date/time, or city (location) in event manager view (103a), together with a status indicator showing the current status of the damage event. The user can also choose to view a customized map (103c) showing the location of selected ones or all of the pending damage reports. The utility dispatcher (111) can also select to generate customized reports based on some or all of the damage reports, such as to determine the areas having the most fallen trees or loss of power.

At step (307), the required response is automatically determined and can be manually reviewed or approved, for example, by utility dispatchers viewing the first responder damage reports on the portal. For example, the system can automatically determine the type of equipment and number of personnel needed at the event based on the damage category and/or analysis of the images, as well as equipment and/or utility crew location and availability.

At step (308), the notification module (109) interacts with the MTIP (106) to determine which field based crews (112) must be notified based on the location of damage, the location jurisdiction, shift times and roles of utility personnel. Field based utility crews and crew supervisors (112) receive personalized notifications in the form of rich text messages, emails and in-app notifications. They may use a dedicated location-based self-configuring damage viewing mobile application (110a) on the utility personnel's mobile device (110) to view the damage reports and plan corrective actions and repairs.

At step (309), the accurate dispatch orders/work orders are prepared at the control room personal computer running a Javascript-capable browser or similar environment (105), for example, for utility crews, specifying the nature of equipment, personnel and materials required. At step (310), the crews are routed to the exact damage address contained in the damages report to complete the repairs, hence reducing misdirected dispatches. For example, the central web portal (103) can transmit a notification to the utility personnel (112) via the utility personnel mobile device (110), possibly within the damage viewing application (110a) requesting the utility personnel (112) to go to the event location. The crew restores the power if safe and feasible. At step (311), the dispatcher and/or crew updates the damage ticket status to cleared or repaired. Finally at step (312), the municipalities and towns are allowed to view the updated ticket status of local utility damage events on the central web portal.

The central web portal (103) also tracks the status of each damage event at each step, and associates the status with the appropriate information. For example, when the web portal (103) receives a damage report, it associates a status of pending or submitted with that report. When the web portal (103) dispatches a crew to that location, it can associate a status of utility crew assigned. In addition, other steps can be provided, such as that the utility crew can indicate whether it accepts a damage order, which is then transmitted to the web portal (103) and the status of the damage report is updated accordingly. And the utility crew can indicate if it is on the way to the damage event, and the status can likewise be updated. The crew can transmit that information via the utility mobile device (110) to the web portal (103) via the MTIP (106), which then updates the status on the web portal for use by the utility dispatcher (111) and can also send the updated status via the notification module (109) to the first responder mobile device (104) and utility mobile device (110), where an appropriate status indicator is associated with that report and can be displayed.

In one illustrative non-limiting embodiment of the invention, supervisory utility personnel (112) can receive notification of every first responder damage report, or access that information via the web portal (103). For example, once the first responder damage report is received by the web portal (103), the utility dispatcher (111) can automatically or manually send it to the supervisory utility personnel mobile device (112). The supervisor utility personnel can then review the details of each report and assist with the dispatch and repair of the damage event. The web portal (103) or the damage viewing mobile app (110a) can also generate customized maps and/or reports for the supervisor, as above. The mobile devices (110) can also communicate directly with another utility crew or crew supervisor device (110), so that reports can be forwarded from one mobile device (110) to another.

It is further noted that the steps of FIGS. 3(a), 3(b) are only an exemplary non-illustrative embodiment of the invention. The operation can proceed in any suitable manner. For instance, the MTIP can determine priority, step (304) and then notifications can be sent, step (303), to the various users that includes priority information.

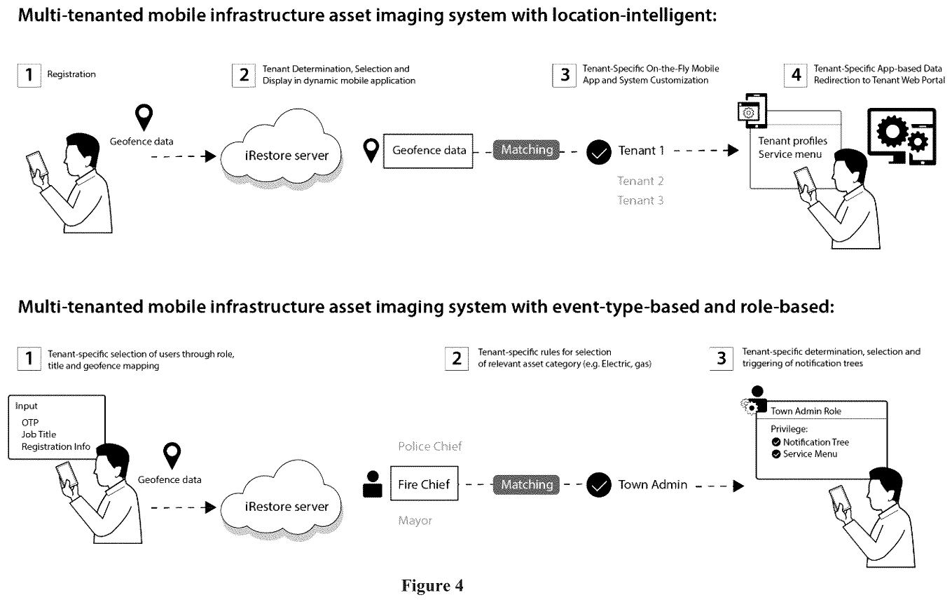

FIG. 4 illustrates how a preferred embodiment can dynamically reconfigure itself to serve multiple geographically dispersed “tenants” or asset owners and operators. Upon download and registration of the mobile application, the system detects the location of the new user and automatically reconfigures the app, system and all related communication and notification rules based on the tenant and service (e.g., electric service in Cleveland, Ohio). The multi-tenanted system can detect damage report type and location to automatically select the utility tenant whose asset is damaged and notify relevant users based on dynamically determining the category of asset damaged and trigger specific rules for notification of workers best able to address the damage reported in the event. The multi-tenanted infrastructure asset imaging system has event and role based: utility tenant-specific selection of users through role, title and geofence mapping; utility tenant specific rules of selection for relevant asset category (e.g., electric, gas); and utility tenant specific determination, selection and triggering of notification trees.

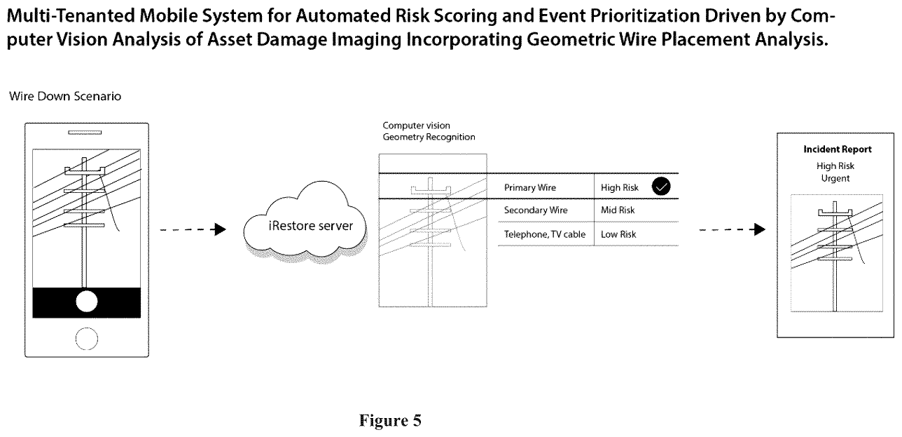

FIG. 5 is a multi-tenanted mobile system for automated risk scoring and event prioritization driven by computer vision analysis of asset damage incorporating geometric wire placement analysis. It shows in more detail how a preferred embodiment is implemented (e.g., using computer vision algorithms) to analyze the incoming imaging and determine relative risk and event priority. Given that high, and low voltage distribution wires, also known as primary wires and secondary and service wires are placed in a known geometric order vertically arrayed on a pole, it is possible to identify with better than an estimated 85% probability whether a particular downed wire is a primary or secondary (or service) wire. Wire circumference can also be used to supplement wire placement geometry. Geometries can vary by utility pole construction standards and the MTIP (106) may be configured to “pre-train” the machine vision engine for each utility tenant. There is also the potential for the wire to be a non-hazardous telephone or cable television wire, which are arrayed vertically further below the electric service wires. Upon examination of the image accompanying the asset damage report, the MTIP (106) can automatically analyze an incoming image from a first responder report, flag it as a likely wire type and recommend an event priority.

Image analysis can be completely automated or can be done with a view to assist and supplement human judgment and to eliminating delays and errors in handling damage reports. The objective is to identify the highest risk damage events first before proceeding to evaluate other events. This allows dispatchers working on thousands of events during a major storm or outage to quickly assess the most critical events while not losing sight of the next level of priority.

The most critical issues of line damage involve downed high-voltage distribution lines or primaries. Downed primaries may be energized or de-energized. Primaries “down and burning” (i.e., still energized) are among the most dangerous damage types that are reported using the application. Primary wires are almost always situated at the top of the pole. The MTIP (106) can rotate the image until poles are vertically oriented to permit the images to be better analyzed for downed primaries, which will then appear to the MTIP (106) as curvilinear in shape rather than straight lines with minor deviation that may be expected due to weight and temperature related sagging. In addition to position, the MTIP can further analyze images based on other factors and information such as relative or expected cable size and/or the damage category and sub-category identified by the first responder in the first responder damage report. For instance, if a utility pole is down, the MTIP can analyze the image to identify objects having the size and shape of a utility pole and cables. By flagging “potential downed primaries,” in an automated manner when thousands of events are vying for the dispatcher's attention during a major event, the system can ensure that these serious damage reports are reviewed on a priority basis, reducing the room for omission or review error.

In one aspect of a preferred embodiment, the utilities may enhance functionality by integrating the system for digitally gathering and disseminating real-time visual intelligence on utility asset damage with third party outage management software or other enterprise systems.

Hence, a preferred embodiment provides a system, which empowers the first responders with intuitive tools to quickly report damage and send the GPS-encoded pictures to pinpoint damage, thereby providing “eyes on” the scene, enabling virtual and detailed damage assessment and prioritized damage response. A preferred embodiment reduces unnecessary truck trolls, restores power faster and improves community relations and customer satisfaction.

A preferred embodiment enables external field-based personnel, specifically municipal first responders, to report outage-causing grid damage directly to utility dispatchers (111) and also leverage the notification engine (109) to directly notify relevant utility field personnel (112) on their mobile devices (110) with jurisdictional and temporal responsibility for responding to the reported damage. The preferred embodiment provides a simple, easily implementable, secure and stand-alone system that overcomes data vulnerability or cyber security risk to the utility. A preferred embodiment also improves communication and collaboration between municipalities and utilities, and enhances the inter-organizational transparency of the damage assessment and outage response process.

Thus, it will be recognized that the system and method of the present invention solves important problems of digitally gathering and disseminating real-time visual intelligence that is vital to a utility's ability to respond effectively and in a timely manner to repair damage that caused the power outage. The system enables accurate and detailed information (pictures) to be provided by a first responder (104) and immediately sends that information to the appropriate utility crew (110), dispatchers (105) and towns (115) for technical analysis and dispatch. The invention permits a first responder (107), via the first responder mobile device (104), to provide meaningful and accurate information to the utility dispatcher (111), and to field based utility personnel (112) via the web portal (103) and the damage viewing mobile application (110a), by generating a damage report that includes one or more pictures. The damage report only includes information that a layperson can provide, to eliminate inaccuracies that can lead to a loss of time and resources. The first responder, who need not acquire utility expertise, is not required to provide any technical descriptions of the damage event, while at the same time the pictures enable a utility expert to quickly and accurately assess the situation and the resources that will be needed to effect repairs and restore service.

In addition, the first responder (107) directly communicates with the utility dispatcher (111) via the MTIP (106) and the central web portal (103), and even the field based utility personnel (112) via the damage viewing mobile application (110a) running on Mobile Device (110) completely bypassing the 911 dispatcher and enabling a quicker assessment and response time by the utility. That is, the first responder mobile device (104) transmits the first responder damage report directly to the MTIP (106) which (together with the notifications module (109)) directly transmits data to the utility mobile device (110) and directly makes information available to selected utility tenants via the web portal (103).

Still further, the system allows damage reports to be more accurately prioritized by providing images that enable utility personnel (including dispatchers) to immediately analyze the event and dispatch the appropriate utility crew, as well as to enable automatic prioritization and dispatch. The first responder mobile device (104) automatically appends location data to the first responder damage report, which eliminates inaccuracies in location of the damage event. The MTIP is a utility industry-specific technical solution that evaluates the location and type of report to determine which utility tenant the first responder report belongs to (based on geo-fences stored for each utility tenant's service boundary). The MTIP then customizes all aspects of the experience for that utility tenant with the first responder mobile application (101) running on the first responder mobile device (104), the central web portal (103) accessed by utility dispatchers (111) on control room PCs (105) running a Javascript capable browser or similar environment. The MTIP can then use the notification module (109) to send text message or email notifications to utility field personnel (112) on their mobile device (110) and also to a location-based self-configuring damage viewing mobile application (110a) in the form of an “app push” notification.

The first responder application (110a) can continue to operate in “offline” mode if the first responder mobile device loses cellular data connection. In this case the application will store the images and metadata on the device and allow a synchronization to take place once the user's mobile device regains its cellular data connection. GPS data can still be accurately captured without a cellular data connection and then the street address “reverse looked up” at the time of synchronization with MTIP.

The first responder app can also optionally work with commercially available external GPS receivers to enhance the location accuracy of the first responder damage report. The first responder mobile application would then receive location information from the GPS receiver via a Bluetooth connection and rely on the external GPS receiver instead of the mobile device, providing a degree of GPS accuracy that may be doubled in terms of resolution, for example, the GPS margin for location error can be reduced to a 7-foot radius instead of a 14-foot radius. (the GPS receiver itself is not part of the invention)

The first responder app can also optionally work with commercially available external Indoor location systems to enhance the location accuracy of the first responder damage report if submitted while indoors, for example within a high rise building or in proximity of skyscrapers. The first responder mobile application would then provide all other metadata and imaging and rely on the external indoor location service instead of the mobile device. (the indoor location system itself is not part of the invention)

If a fire prevents access or proximity to a given utility asset damage location, an enhancement to the first responder damage application can optionally enable the application to receive information from an external thermal imaging or infrared or LIDAR receiver (the IR or LIDAR receiver itself is not part of the invention) to obtain better or more accurate images from the first responder mobile device via Bluetooth and to then combine those images with the remaining metadata at the MTIP.

If flooding prevents first responders from obtaining vehicular access, an optional enhancement to the first responder damage application can enable the application to receive information from an external unmanned aerial vehicle or drone (the Drone itself is not part of the invention) to obtain better or more accurate images when roads are not navigable due to flooding and to then combine those images with the remaining metadata at the MTIP.

Location can also be obtained separately from another system or subsystem such as an existing, external vehicle tracking system, and combined with images and metadata to file the first responder damage report in a manner similar to its normal operation, where location data would be received separately from the images and metadata and combined into a single report at the MTIP.

The mobile application allows the first responder user to input a second location for the location of the damage (for example if there is equipment on fire and their location is across the street or several houses down.) in this case. The application would communicate both the user indicated location and the actual device location to the MTIP, th and central portal and the damage viewing mobile application.

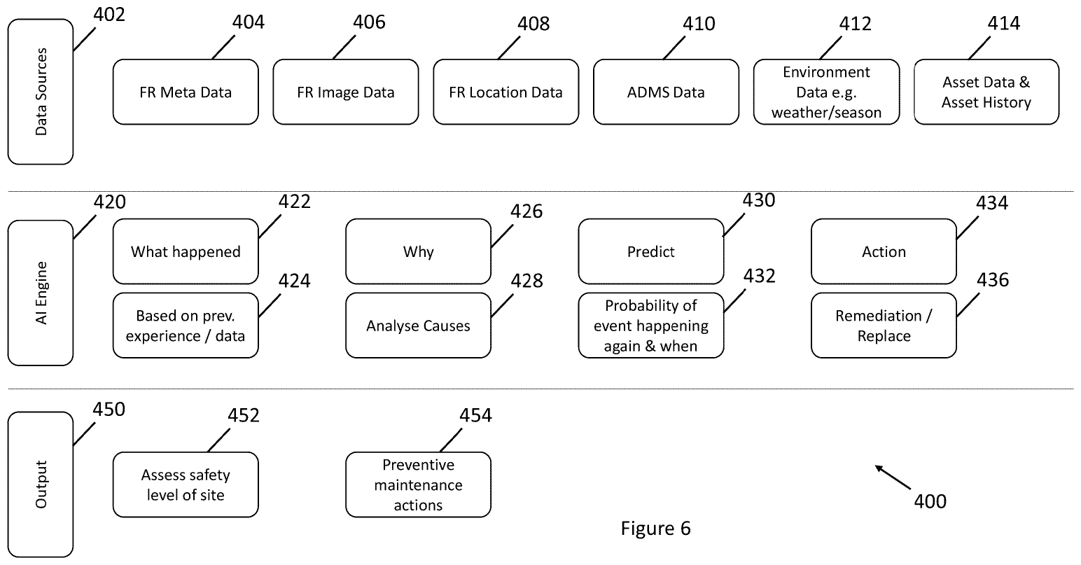

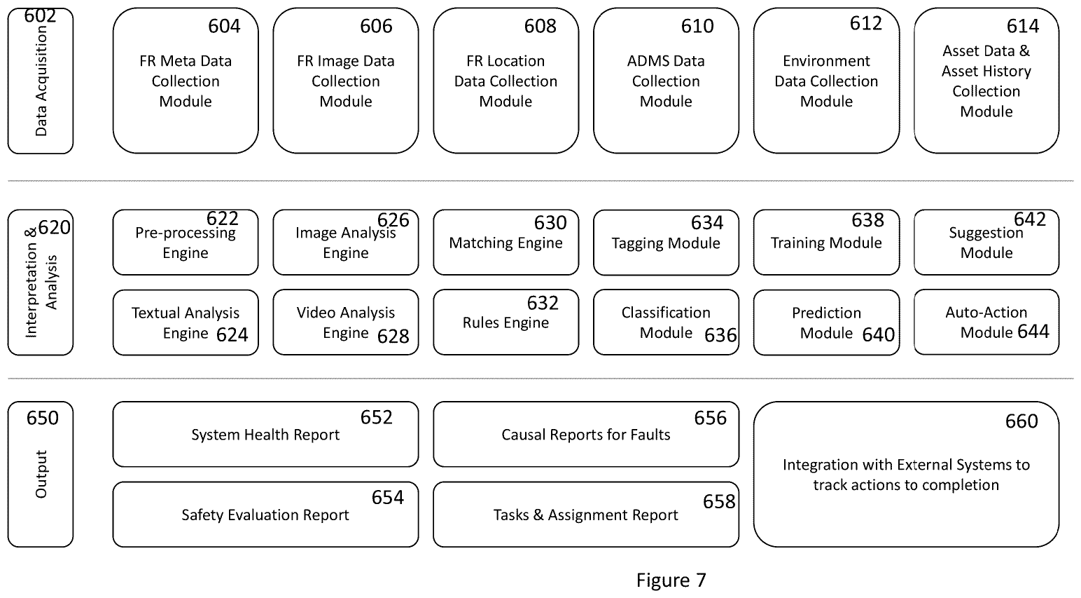

Turning to FIGS. 6, 7, the disclosure includes a comprehensive set of subsystems that are designed to collectively aggregate data from external hardware sources and cloud, intelligently interpret that image data using machine vision AI algorithms and to then output the resulting analysis to third party software and hardware systems that govern fault correction and automated switching response. Collectively these subsystems make the first responder application a “self-healing” system that combines crowdsourced data with hardware-based interfaces and grid switching capability.

The system includes a Data Acquisition Layer 402 for First Responder Data Pre-Processing, and AI and Machine Vision based Image Analysis Interpretation Layer 420, and an Output Layer 450.

The Data source layer 602 processes data sources 402, and includes a first responder metadata collection module 604 that processes first responder meta data 404, first responder image data collection module 606 that processes first responder image data 406, first responder location data collection module 608 that processes first responder location data 408, Automated Distribution Management System (ADMS) data collection module 610 that processes ADMS data 410, environment data collection module 612 that processes environment data 412, and asset data and asset history data collection module 614 that processes asset data and asset history data 414.

The first responder metadata collection module 604 aggregates and pre-processes key metadata 404 including address, type of fault and other report attributes, tuning the system for further input. The image collection module 606 gathers and pre-processes images 406 for analysis. The ADMS data collection module 610 gathers data 410 from and interfaces with a digital SCADA-based grid management system. The environment data analysis module 612 collects sensor and third-party environment data 412 on current weather and temperature conditions, pre-processing reports for various damage types (overheating of equipment during hot summer months for example). The asset data history processing module 614 stores and records past asset failure data 414 that may be used in projecting or predicting the probability of future failures given various environmental and other fault conditions.

The AI and Machine Vision based Image Analysis and Interpretation Layer 420 includes a What happened module 422, Why it happened module 426, Prediction module 430, and Action module 434. The pre-processing engine 622 determines which types of analysis are to be applied and parameterizes the image analysis subsystems in this layer. The image analysis engine 626 leverages various AI and machine vision algorithms to process first responder images. The training module 638 uses thousands of images to train the system to recognize and match analyzed images to one of 20 or more damage categories. A video analysis engine 628 performs the same analysis on video files acquired from the application. A matching engine 630 matches the analyzed image or video to a predefined number of matched damage categories, e.g. “Leaking Transformer” or “Broken Pole,” assigning a weighted probability of match to each of the auto-assigned categories.

Once the matching has been performed, the tagging module 634 appends a “tag cloud” of matched damage categories. A rules engine 632 allows the system to automatically reject “false positives” based on a set of rules that govern true damage categorization. Once matched, the classification module 636 then further categorizes the work to be performed so that it may most efficiently be dispatched based on skill requirements, location and other factors. A prediction module 640 allows the subsystem to analyze images for future potential failures and for preventive action to be taken in advance of an actual fault. An auto-action module 644 governs the content streamed to external system interfaces allowing actions to be performed in external software subsystems, or used to actuate switching systems such as those in an ADMS.

Unlike other generic image processing and analysis systems, the invention focuses on a unique capability not previously extant. Specifically, grid operators find their existing systems provide data on devices that are “convicted” of a fault necessitating a dispatch or truck roll to determine root cause and to then apply corrective measures manually. The invention allows the analysis to uniquely identify, tag and categorize root causes of grid damage, pinpointing the precise location for future remediation.

The Output and Action Layer 650 controls output 450. Various external reporting and interaction tools enable the insights gained from matching and categorizing faults to be used to take corrective action. Such action may take the form of a manual dispatch in a third-party work management system. It may also include ADMS integration to enable software-based switching control of equipment designed to protect citizens during an outage, offering fine-grained control over the size, scope and extent of the “self-healing” subsystem; root cause analysis followed by external fault isolation and automatic SCADA based switching with the ability to dramatically enhance public safety.

The invention includes a cloud and edge based Artificial Intelligence/Machine Learning (AI/ML) implemented both in the app and cloud based multi-tenant intelligent platform (MTIP) 106. Built using algorithms that leverage internal and third-party AI services and platforms, the app-based and cloud-based AI/ML subsystem continuously analyzes and processes first-responder reported grid safety hazards and intelligently recommends a utility hazard disposition, all in real time.

Mobile and MTIP based AI/ML Machine Vision Hazard Detection and Classification. The edge-based and MTIP/cloud-based AI/ML subsystem not only receives incoming images but processes those images in real time using multiple ML frameworks. This processing results in the event report being classified using machine vision that detects anomalous or abnormal operating conditions and automatically classifies hazard type into one or more of the following categories:
1. Arboreal intrusion into distribution network lines, with the added ability to probabilistically prioritize high-voltage (primary) line events
2. Downed or low-hanging distribution network lines, with the added ability to probabilistically prioritize high-voltage (primary) line events
3. Broken or damaged electric poles, with the ability to recognize accompanying downed or low-hanging distribution network lines, with the added ability to probabilistically prioritize high-voltage (primary) line events
4. Electric equipment hazards including leaks, breakage, or damage
5. Other, configurable, locale-specific hazard types

The machine vision based hazard detection and classification system is able to automatically classify such grid-related public safety hazards into about 20 hazard classes.

Mobile and MTIP based hazard disposition recommendation engine. Once hazard class has been identified, the system can automatically determine the nearest and best-matched utility supervisors and/or crews and matching equipment. Responding utility personnel then have access to a companion utility responder app whose function it is to process incoming hazard reports. The app utilizes an AI/ML-based recommendation engine to automatically evaluate multiple hazard disposition alternatives. Disposition alternatives include guarding, make-safe and remedial responses. The recommendation engine interacts with a configurable rules engine that dynamically evaluates multiple factors including public and worker safety, network reliability and outage duration reduction. The app then displays the generated hazard disposition recommendations.

Control Subsystem for Hardware switching effected via ADMS SCADA integration. Another unique feature of the invention is a control subsystem within the MTIP that has the ability to automatically drive a change in the actual network hardware state as a result of the above disposition recommendations. Following MTIP integration with an Automated Distribution Management System (ADMS) the system can utilize multiple Supervisory Control and Data Acquisition (SCADA) interfaces to control the operation state and behavior of relevant switching equipment. The switching operation based on the app recommendation to the MTIP and supervisory control center can have the effect of an automated system disposition including fault clearing, switching out faulty or malfunctioning equipment, switching out an entire sub-circuit or line in real time when a grid hazard is recognized, classified and recommended for such action.

The app features a continuous learning system that evaluates response and network reconfiguration actions to further enhance its AI/ML based hazard disposition recommendation engine.

All of the above features of the invention offer a number of benefits, including: enhances PUBLIC SAFETY, improves grid RELIABILITY (reduces outages), and increases RESILIENCY (ability to quickly recover from outages)

The system and method of the present invention include operation by one or more processing devices, including the mobile devices (104), MTIP (106), control room personal computer running a Javascript capable browser or similar environment (105) interacing with the web portal (103) and with the communication module (102). It is noted that the processing devices can be any suitable device, such as a computer, server, processor, microprocessor, PC, tablet, smartphone, or the like. The processing devices can be used in combination with other suitable components, such as a display device (monitor, LED screen, digital screen, etc.), memory or storage device, input device (touchscreen, keyboard, pointing device such as a mouse), wireless module (for RF, Bluetooth, infrared, WiFi, etc.). The information may be stored on a computer hard drive, memory, or on any other appropriate data storage device, which can be located at or in communication with the processing device. The entire process is conducted automatically by the processing device, and without any manual interaction. Accordingly, unless indicated otherwise the process can occur substantially in real-time without any delays or manual action. The mobile devices (104), and especially the first responder mobile device (104) includes GPS and an imaging device such as a high resolution camera to capture images.

It is to be understood, however, that even though several characteristics and advantages of a preferred embodiment have been set forth in the foregoing description, together with details of the structure and function of the preferred embodiment, the disclosure is illustrative only. Changes may be made in the details, especially in matters of shape, size, and arrangement of parts within the principles of the preferred embodiment to the full extent indicated by the broad general meaning of the terms in which the appended claims are expressed. Newer devices such as bodycams, smartwatches, smartglasses, dashcams, wearable sensors, etc. may all be used by first responders in lieu of the mobile device (104) as part of the preferred embodiment. And while the notification module (109) is shown separate but located with the MTIP (106), those components can be remote from one another or integrated with one another.

1. A system for digitally gathering and disseminating real-time visual intelligence on utility asset damage enabling automated priority analysis and enhanced utility outage response, the system comprising:
a first responder mobile application installed onto a Global Positioning System (GPS) enabled first responder mobile device having an image capturing device, said first responder mobile application configured to operate the image capturing device to capture an image of the utility damage event and automatically determine a damage event location based on a location of the first responder mobile device when the image is captured, said first responder mobile application further configured to generate a first responder damage report of the utility damage event that includes the captured image and damage event location and transmit the first responder damage report;
a multi-tenanted intelligent platform (MTIP) configured to receive the first responder damage report from the first responder mobile device, and dynamically determine which utility tenant the report must be automatically assigned to based on report location and damage type, and automatically customize the first responder app, the utility central portal and the damage viewing mobile application for that utility tenant, the MTIP configured to compute a priority for the damage report by pattern-matching, relevance analysis and image processing of the captured image;
a central web portal for utility dispatchers and utility control room personnel to view and manage damage reports in multiple formats including map-based views, event management list views and an administrative capability allowing the utility tenant and their admin(s) to manage users, privileges and notification rules and jurisdictions; and
a selective notification module featuring contextual notification based on geo-location both of the damage report and of the utility field personnel or their dispatch location.

2. The system of claim 1, wherein said selective notification is based on user relevance defined in the form of utility users' or crews' organizational role or department, geographic jurisdiction, type of service required and shift timings.

3. The system of claim 1, wherein said selective notification module configured to transmit images and metadata from first responder damage report directly to relevant utility users including utility crews and local crew supervisors.

4. The system of claim 1, wherein notifications can be personalized and include any combination of text messages, emails and in-app notifications, the latter option requiring utility field users to download and install the damage viewing mobile application.

5. The system of claim 1, wherein the multi-tenanted intelligent platform is further configured to store the first responder damage report associating it with the location-appropriate utility tenant and to enable the utility dispatcher to assign various dispositions to the damage report using the central web portal, a town/county delimited version of which may be accessed by municipalities to provide response and repair assistance; and
a central web portal with interfaces to an external geographic information system (GIS), wherein said central web portal can group, sort, catalogue and organize the damage assessment reports for the display on the control room PC and on the mobile device of the utility field personnel in the damage viewing mobile application.

6. The system as claimed in claim 1, wherein said first responder is one or more individual such as firefighter, police, field workers or any external source primarily reaching the outage location.

7. The system as claimed in claim 1, wherein said system further disseminates visual intelligence on utility asset damage with plurality of organizations from the multi-tenanted intelligent platform via the central web portal, via the location-based self-configuring damage viewing mobile application and via the town portals, wherein the shared information is used to form a strategy by the organizations to respond to address outage-causing damage rapidly and with the needed resources in the correct sequence at the required locations so that repairs may be effected in shorter times.

8. The system as claimed in claim 1, wherein the first responder damage report includes data pertaining to outage but not limited to the GPS-encoded pictures, videos, text, and digital imagery.

9. A method for digitally gathering and disseminating real-time visual intelligence on utility asset damage enabling automated priority analysis and enhanced utility outage response, the method comprising the steps of:
sending the geo-coded damage imaging and event meta-data to the multi-tenanted intelligent platform by the first responder using a location-based self-configuring mobile application at the utility damage location;
selecting the appropriate utility tenant and creating the utility damage event, time-stamping and storing in the multi-tenanted intelligent platform;
sending notifications via email, text message and app push to relevant utility users including utility dispatchers via a web portal and local crew supervisors via a damage viewing application;
ingesting location, relevance and reported severity of damage and using this data to automatically and algorithmically compute, recommend and communicate event priority by employing pattern-matching, relevance analysis and image processing;
grouping, sorting, cataloging and organizing damage assessment reports for the display on the central web portal;
publishing images and metadata to utility's own geographical information system in the form of map pins which are derived from damage geo-location;
allowing qualified electrical technicians or utility damage assessors and dispatchers to view the damage reports on the central web portal and determining the response required;
disseminating damage reports to utility operations planners for them to prepare dispatch orders/work orders for utility crews by remotely assessing the nature of equipment, personnel and materials required;
routing the crews to exact damage address to complete repairs and restoring the power;
updating job and repair status by dispatcher and crew; and
allowing the municipalities and towns to view updated ticket status of local utility damage events on the town web portal.

10. The method as claimed in claim 9, wherein said central web portal via the MTIP further provides the status updates of the response sent to first responder.

11. The method as claimed in claim 9, wherein said status updated by dispatcher is the state of the outage event such as cleared or repaired.

12. A system for gathering and disseminating real-time visual intelligence of a utility damage event, the system comprising:
a plurality of first responder mobile devices each having a first responder mobile application, a Global Positioning System (GPS), and an image capturing device, wherein the first responder mobile device comprises a smart phone or tablet that moves between geographic locations and the GPS determines a current geographic location of the first responder mobile device, said first responder mobile application configured to operate the image capturing device in response to a manual user operation to capture an image of the utility damage event and automatically determine a damage event geographic location from the current geographic location of the first responder mobile device determined by the GPS when the image is captured, said first responder mobile application presenting to the user damage types and identifying the damage event with a damage type selected by the user, wherein said first responder mobile application further configured to generate a first responder damage report of the utility damage event that includes the captured image, the user-selected damage type, and the damage event geographic location and transmit the first responder damage report; and
a multi-tenanted intelligent platform (MTIP) configured to receive the first responder damage report from the first responder mobile device, assign appropriate repair personnel based on relevant skills and proximity to the geographic locations of the utility damage event based on the first responder damage report, and automatically determine a priority for the first responder damage report by pattern-matching, relevance analysis and image processing of the captured image.

13. The system of claim 12, further comprising:
a central web portal for a plurality of utility tenants to view and manage first responder damage reports at different geographic locations in multiple formats including map-based views, event management list views and an administrative capability allowing the utility tenant and their admin(s) to manage users, privileges and notification rules and jurisdictions;
utility crew mobile devices each having a utility crew mobile application configured to receive and display first responder damage reports as one of the plurality of utility tenants via the central web portal; and
a selective notification module in communication with the MTIP to dynamically determine which of the plurality of utility tenants the first responder can access via the central web portal the first responder damage report based on report geographic location and the user-selected damage type, and select which of the utility mobile devices are to receive the first responder damage report, said selective notification module further forwarding the first responder damage report to the selected utility mobile devices.

14. The system of claim 13, said selective notification module further providing contextual notification based on the geographic location of the first responder damage report and a geographic location of the utility field personnel or their dispatch location.

15. The system of claim 12, wherein said MTIP analyzes the captured image to determine a severity of the damage.

16. The system of claim 15, wherein said MTIP analyzes the captured image to determine if a primary power line is damaged, and assigns a high priority to the first responder damage report if the primary power line is damage.

17. The system of claim 12, wherein the first responder damage report includes a damage type for the utility damage event, and wherein said MTIP analyzes the captured image based on the damage type to determine a severity of the damage.

18. The system of claim 13, wherein the MTIP receives the first responder damage report directly from the first responder mobile device, and transmits the first responder damage report directly to the selected utility crew mobile devices.

19. The system of claim 12, wherein the MTIP provides the first responder damage report to one of a plurality of different types of utility crews based on the user-selected damage type.

20. The system of claim 13, wherein said selective notification module is configured to transmit images and metadata from the first responder damage report directly to relevant utility users including utility crews and/or local crew supervisors.

21. The system of claim 13, said plurality of first responder mobile devices configured to transmit geo-coded damage imaging and event meta-data to said MTIP.

22. The system of claim 13, said MTIP transmitting notifications to relevant utility users via a web portal.
